(19) United States
(12) Patent Application Publication
(10) Pub. No.: US 2020/0268590 A1
(43) Pub. Date: Aug. 27, 2020

(54) Foot Massaging Sock Assembly

(71) Applicant: Jeffrey Wilson, Rock Hill, SC (US)

(72) Inventor: Jeffrey Wilson, Rock Hill, SC (US)

(21) Appl. No.: 16/281,198

(22) Filed: Feb. 21, 2019

(51) Int. Cl. A61H 7/00; A41B 11/00

(52) U.S. Cl. CPC A61H 7/004; A41B 11/007; A61H 2209/00; A61H 2205/106; A61H 2201/165

(57) ABSTRACT

A foot massaging sock assembly includes a sock that is wearable on a foot, and the sock has a sole and a top end. A strap is coupled to the sock and the strap is positioned adjacent to the top end. The strap is wrappable around a user's calf when the sock is worn to tighten the sock around the user's calf. A plurality of massagers is each integrated into the sock and each of the massagers is positioned on the sol. Thus, each of the massagers engages a sole of the foot when the sock is worn and each of the massagers massages the sole of the foot when the sock is worn. A power cord is coupled to and extends away from the sock and the power cord is electrically coupled to each of the massagers. Moreover, the power cord is pluggable into a power source comprising a female electrical outlet.

### CROSS-REFERENCE TO RELATED APPLICATIONS

### STATEMENT REGARDING FEDERALLY SPONSORED RESEARCH OR DEVELOPMENT

Not Applicable

### BACKGROUND OF THE INVENTION

### (1) Field of the Invention

### (2) Description of Related Art including information disclosed under 37 CFR 1.97 and 1.98

The disclosure and prior art relates to sock devices and more particularly pertains to a new sock device for massaging a sole of a user's foot.

### BRIEF SUMMARY OF THE INVENTION

An embodiment of the disclosure meets the needs presented above by generally comprising a sock that is wearable on a foot, and the sock has a sole and a top end. A strap is coupled to the sock and the strap is positioned adjacent to the top end. The strap is wrappable around a user's calf when the sock is worn to tighten the sock around the user's calf. A plurality of massagers is each integrated into the sock and each of the massagers is positioned on the sol. Thus, each of the massagers engages a sole of the foot when the sock is worn and each of the massagers massages the sole of the foot when the sock is worn. A power cord is coupled to and extends away from the sock and the power cord is electrically coupled to each of the massagers. Moreover, the power cord is pluggable into a power source comprising a female electrical outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a foot massaging sock assembly according to an embodiment of the disclosure.

FIG. 2 is a left side view of an embodiment of the disclosure.

FIG. 3 is a cross sectional view taken along line 3-3 of FIG. 2 of an embodiment of the disclosure.

FIG. 4 is a bottom phantom view of an embodiment of the disclosure.

FIG. 5 is a perspective view of an alternative embodiment of the disclosure.

### DETAILED DESCRIPTION OF THE INVENTION

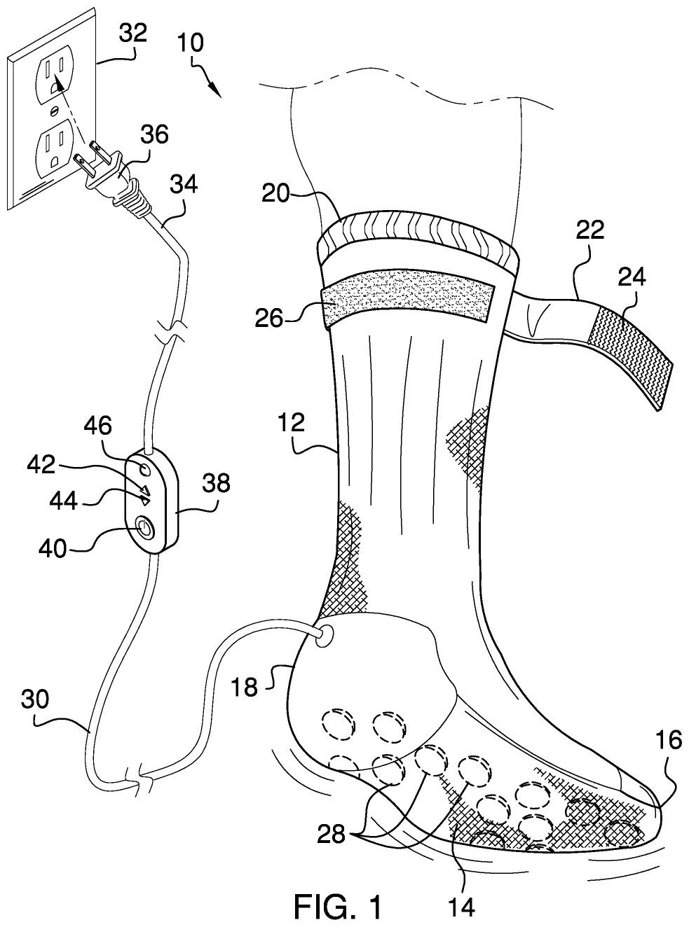

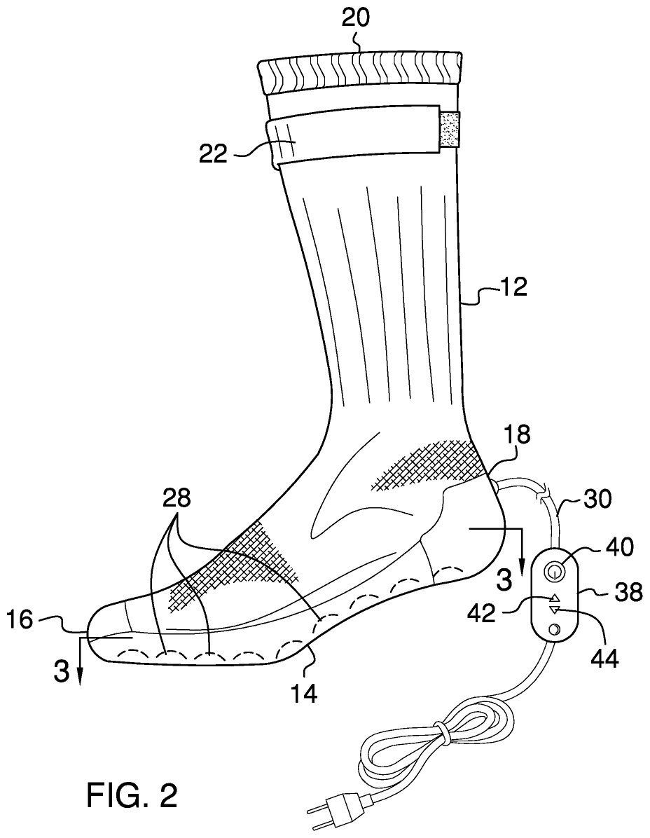

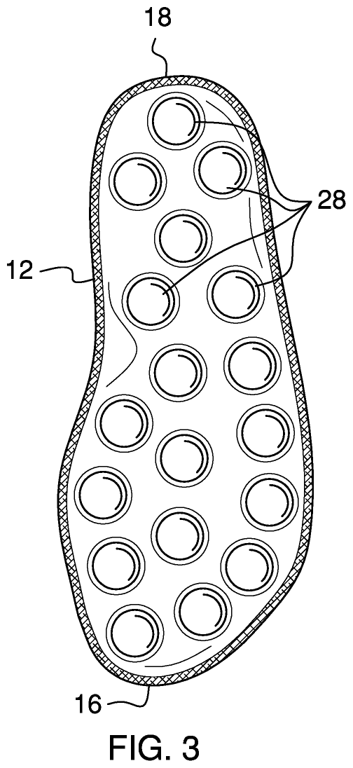

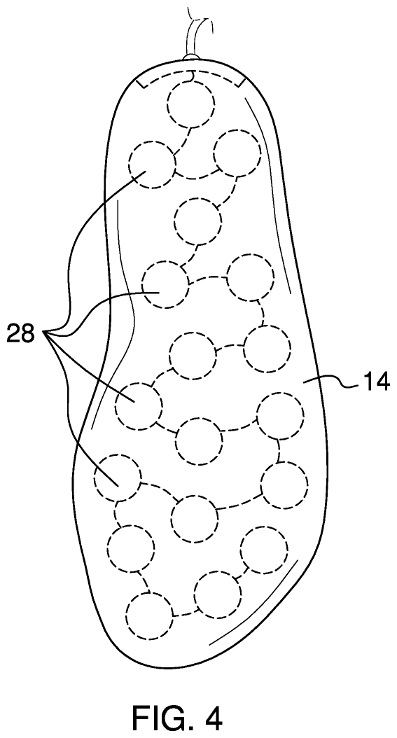

With reference now to the drawings, and in particular to FIGS. 1 through 5 thereof, a new sock device embodying the principles and concepts of an embodiment of the disclosure and generally designated by the reference numeral 10 will be described.

As best illustrated in FIGS. 1 through 5, the foot massaging sock assembly 10 generally comprises a sock 12 that is wearable on a foot. The sock 12 has a sole 14, a toe 16, a heel 18 and a top end 20. The top end 20 is open for insertably receiving the foot. The sock 12 may be a crew sock or other similar sock that extends upwardly along a user's leg when the sock 12 is worn. A strap 22 is coupled to the sock 12 and the strap 22 is positioned adjacent to the top end 20. The strap 22 is wrappable around a user's calf when the sock 12 is worn to tighten the sock 12 around the user's calf.

A first mating member 24 is coupled to the strap 22 and a second mating member 26 is coupled to the sock 12. The second mating member 26 is spaced from the top end 20 of the sock 12, and the first mating member 24 releasably engages the second mating member 26 when the strap 22 is wrapped around the user's calf. Each of the first 24 and second 26 mating members may be hook and loop fasteners or the like.

A plurality of massagers 28 is each integrated into the sock 12 and each of the massagers 28 is positioned on the sole 14. Thus, each of the massagers 28 engages a sole 14 of the foot when the sock 12 is worn. Each of the massagers 28 undulates about a horizontal axis when the massagers 28 are turned on for massaging the sole 14 of the foot when the sock 12 is worn. The massagers 28 are spaced apart from each other and are distributed between the toe 16 and the heel 18. Each of the massagers 28 may be electronic massaging balls or other similar type of deep tissue massager.

A power cord 30 is coupled to and extends away from the sock 12 and the power cord 30 is electrically coupled to each of the massagers 28. The power cord 30 is pluggable into a power source 32 comprising a female electrical outlet for powering the massagers 28. The power cord 30 extends outwardly from the heel 18 and the power cord 30 has a distal end 34 with respect to the sock 12. A male plug 36 is electrically coupled to the distal end 34 for plugging into the female electrical outlet.

A control 38 is coupled to the power cord 30, the control 38 is electrically coupled to the power cord 30 and the control 38 is in electrical communication with each of the massagers 28. The control 38 has a power button 40 for turning each of the massagers 28 on and off. Additionally, the control 38 has an increase button 42 for increasing an intensity of the massagers 28 toward a maximum intensity and the control 38 has a decrease button 44 for decreasing the intensity of the massagers 28 toward a minimum intensity. The control 38 has a light emitter 46 thereon and the light emitter 46 is electrically coupled to the power button 40. The light emitter 46 is turned on to emit light when the massagers 28 are turned on for visually alerting the user that the massagers 28 are turned on.

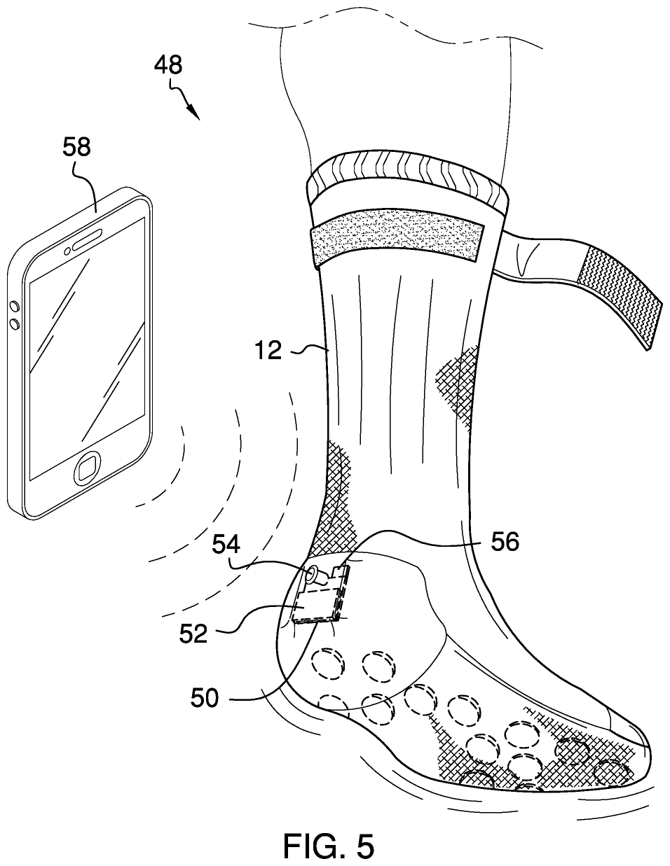

In an alternative embodiment 48 as shown in FIG. 5, a power supply 50 is integrated into the sock 12, the power supply 50 is electrically coupled to each of the massagers 28 and the power supply 50 comprises at least one battery 52. Continuing in the alternative embodiment, a charge port 54 is coupled to the sock 12. The charge port 54 is electrically coupled to the power supply 50 and a charger is electrically plugged into the charge port 54 for charging the at least one battery 52. A transceiver 56 is integrated into the sock 12 and the transceiver 56 is electrically coupled to the power supply 50. Moreover, the transceiver 56 is in wireless electrical communication with a remote control 58, such as a smart phone or other electronic device, thereby facilitating the massagers 28 to be remotely turned on and off.

In use, the sock 12 is worn when the user needs a foot massage to relieve foot tension and pain. The power cord 30 is plugged into the female electrical outlet and the control 38 is manipulated to turn on the massagers 28. Thus, the massagers 28 massage the sole of the user's foot while the sock 12 is being worn. In this way the massagers 28 relieve physical symptoms associated with standing on one's feet for extended periods of time, participating in athletic events or any other activity that causes foot fatigue and discomfort.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A foot massaging sock assembly being configured to massage a foot, said assembly comprising:
a sock being wearable on a foot, said sock having a sole, a toe, a heel and a top end, said top end being open for insertably receiving the foot;
a strap being coupled to said sock, said strap being positioned adjacent to said top end, said strap being wrappable around a user's calf when said sock is worn wherein said strap is configured to tighten said sock around the user's calf;
a plurality of massagers, each of said massagers being integrated into said sock, each of said massagers being positioned on said sole wherein each of said massagers is configured to engage the sole of the foot when said sock is worn, each of said massagers undulating about a horizontal axis when said massagers are turned on wherein said plurality of massagers is configured to massage the sole of the foot when said sock is worn, said massagers being spaced apart from each other and being distributed between said toe and said heel; and
a power cord being coupled to and extending away from said sock, said power cord being electrically coupled to each of said massagers, said power cord being pluggable into a power source comprising a female electrical outlet.

2. The assembly according to claim 1, further comprising:
a first mating member being coupled to said strap; and
a second mating member being coupled to said sock, said second mating member being spaced from said top end of said sock, said first mating member releasably engaging said second mating member when said strap is wrapped around the user's calf.

3. The assembly according to claim 1, further comprising:
said power cord extends outwardly from said heel, said power cord having a distal end with respect to said sock, said distal end having a male plug being electrically coupled thereto for plugging into the female electrical outlet;
a control being coupled to said power cord, said control being electrically coupled to said power cord such that said control is in electrical communication with each of said massagers;
said control having a power button for turning each of said massagers on and off;
said control having an increase button for increasing an intensity of said massagers toward a maximum intensity;
said control having a decrease button for decreasing the intensity of said massagers toward a minimum intensity;
said control having a light emitter being coupled thereto, said light emitter being electrically coupled to said power button, said light emitter being turned on to emit light when said massagers are turned on wherein said light emitter is configured to visually alert the user that said massagers are turned on.

4. A foot massaging sock assembly being configured to massage a foot, said assembly comprising:
a sock being wearable on a foot, said sock having a sole, a toe, a heel and a top end, said top end being open for insertably receiving the foot;
a strap being coupled to said sock, said strap being positioned adjacent to said top end, said strap being wrappable around a user's calf when said sock is worn wherein said strap is configured to tighten said sock around the user's calf;
a first mating member being coupled to said strap;
a second mating member being coupled to said sock, said second mating member being spaced from said top end of said sock, said first mating member releasably engaging said second mating member when said strap is wrapped around the user's calf;
a plurality of massagers, each of said massagers being integrated into said sock, each of said massagers being positioned on said sole wherein each of said massagers is configured to engage the sole of the foot when said sock is worn, each of said massagers undulating about a horizontal axis when said massagers are turned on wherein said plurality of massagers is configured to massage the sole of the foot when said sock is worn, said massagers being spaced apart from each other and being distributed between said toe and said heel;
a power cord being coupled to and extending away from said sock, said power cord being electrically coupled to each of said massagers, said power cord being pluggable into a power source comprising a female electrical outlet, said power cord extending outwardly from said heel, said power cord having a distal end with respect to said sock, said distal end having a male plug being electrically coupled thereto for plugging into the female electrical outlet; and
a control being coupled to said power cord, said control being electrically coupled to said power cord such that said control is in electrical communication with each of said massagers, said control having a power button for turning each of said massagers on and off, said control having an increase button for increasing an intensity of said massagers toward a maximum intensity, said control having a decrease button for decreasing the intensity of said massagers toward a minimum intensity, said control having a light emitter being coupled thereto, said light emitter being electrically coupled to said power button, said light emitter being turned on to emit light when said massagers are turned on wherein said light emitter is configured to visually alert the user that said massagers are turned on.

5. The assembly according to claim 4, further comprising a power supply being integrated into said sock, said power supply being electrically coupled to each of said massagers, said power supply comprising at least one battery.

6. The assembly according to claim 5, further comprising a charge port being coupled to said sock, said charge port being electrically coupled to said power supply, said charge port having a charger being electrically plugged therein for charging said at least one battery.

7. The assembly according to claim 6, further comprising a transceiver being integrated into said sock, said transceiver being electrically coupled to said power supply, said transceiver being in wireless electrical communication with a remote control wherein said massagers are configured to be remotely turned on and off.
